(19) United States
(12) Patent Application Publication
(10) Pub. No.: US 2026/0333088 A1
(43) Pub. Date: Oct. 22, 2026

(54) DROOP COMPENSATION FOR ANALOG INTERFACES BETWEEN INTEGRATED CIRCUITS OF A USER EQUIPMENT (UE)

(71) Applicant: QUALCOMM Incorporated, San Diego, CA (US)

(72) Inventors: Madhav VENKATESWARAN, Hyderabad (IN); Saranyan NAGARAJAN, Hyderabad (IN); Krishnamitra TANUKU, Hyderabad (IN); Srinivas PACHAVA, Hyderabad (IN); Mohammad AFAASH, Kasaragod (IN); Yogendra Umesh ITANKAR, Hyderabad (IN); Saishankar Katri PULLIYAKODE, Hyderabad (IN); Kapil BHATTAD, Bangalore (IN)

(21) Appl. No.: 19/486,236

(22) PCT Filed: May 22, 2024
(86) PCT No.: PCT/US2024/030539

§ 371 Date: Nov. 20, 2025

(30) Foreign Application Priority Data
Jul. 12, 2023 (IN) 202341046893

(51) Int. Cl. H04W 24/08; H04B 1/00; H04W 24/06

(52) U.S. Cl. CPC H04W 24/08; H04B 1/0039; H04W 24/06

(57) ABSTRACT

Various aspects of the present disclosure generally relate to wireless communication. In some aspects, a user equipment (UE) may detect, via a baseband modem integrated circuit (IC) of the UE, a signal. The UE may apply, via the baseband modem IC, a droop compensation to reduce droop associated with the signal, wherein: the droop is reduced based at least in part on an undroop filter configuration, the undroop filter configuration is associated with a bin selected from a plurality of available bins, and the bin is selected based at least in part on a trace capacitance load, associated with an analog in-phase and quadrature (IQ) interface between the baseband modem IC and a radio frequency (RF) IC of the UE, being within a range of capacitance loads associated with the bin. Numerous other aspects are described.

### CROSS-REFERENCE TO RELATED APPLICATION

This Patent Application claims priority to Indian Provisional Patent Application No. 202341046893 filed on Jul. 12, 2023, entitled “DROOP COMPENSATION FOR ANALOG INTERFACES BETWEEN INTEGRATED CIRCUITS OF A USER EQUIPMENT (UE),” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for droop compensation for analog interfaces between integrated circuits of a user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more memories may include instructions executable by the one or more processors to cause the UE to detect a signal. The one or more memories may include instructions executable by the one or more processors to cause the UE to apply a droop compensation to reduce droop associated with the signal. The undrooping may be based at least in part on an undroop filter configuration. The undroop filter configuration may be associated with a bin selected from a plurality of available bins. The bin may be selected based at least in part on a trace capacitance load, associated with an analog in-phase and quadrature (IQ) interface between a baseband modem integrated circuit (IC) of the UE and a radio frequency (RF) IC of the UE, being within a range of capacitance loads associated with the bin.

Some aspects described herein relate to a method of wireless communication performed by a UE. The method may include detecting, by a baseband modem IC of the UE, a signal. The method may include applying, by the baseband modem IC, a droop compensation to reduce droop associated with the signal. The undrooping may be based at least in part on an undroop filter configuration. The undroop filter configuration may be associated with a bin selected from a plurality of available bins. The bin may be selected based at least in part on a trace capacitance load, associated with an analog IQ interface between a baseband modem IC of the UE and an RF IC of the UE, being within a range of capacitance loads associated with the bin.

Some implementations described herein relate to a non-transitory computer-readable medium storing one or more instructions for wireless communication. The one or more instructions, when executed by one or more processors of a UE, may cause the UE to detect a signal. The one or more instructions, when executed by one or more processors of the UE, may cause the UE to apply a droop compensation to reduce droop associated with the signal. The undrooping may be based at least in part on an undroop filter configuration. The undroop filter configuration may be associated with a bin selected from a plurality of available bins. The bin may be selected based at least in part on a trace capacitance load, associated with an analog IQ interface between a baseband modem IC of the UE and an RF IC of the UE, being within a range of capacitance loads associated with the bin.

Some implementations described herein relate to an apparatus for wireless communication. The apparatus may include means for detecting, by a baseband modem IC of the apparatus, a signal. The apparatus may include means for applying a droop compensation to reduce droop associated with the signal. The undrooping may be based at least in part on an undroop filter configuration. The undroop filter configuration may be associated with a bin selected from a plurality of available bins. The bin may be selected based at least in part on a trace capacitance load, associated with an analog IQ interface between the baseband modem IC and an RF IC of the apparatus, being within a range of capacitance loads associated with the bin.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of circuit board layout variations, in accordance with the present disclosure.

FIG. 5 is a diagram illustrating an example associated with droop compensation for analog interfaces between integrated circuits of a UE, in accordance with the present disclosure.

FIG. 6 is a diagram illustrating an example associated with undroop responses across bins, in accordance with the present disclosure.

FIG. 7 is a diagram illustrating an example process associated with droop compensation for analog interfaces between integrated circuits of a UE, in accordance with the present disclosure.

FIG. 8 is a diagram of an example apparatus for wireless communication, in accordance with the present disclosure.

### DETAILED DESCRIPTION

A modem architecture may have a radio frequency (RF) front-end and a modem on different integrated circuit (IC) packages, which may allow for separation and for independent selection of nodes, size, and/or power optimization for each IC package. In a circuit board, an analog in-phase and quadrature (IQ) interface may be employed between an RF IC and a baseband modem IC. A circuit board routing and packaging solution may be designed for connecting an analog baseband output from the RF IC to the baseband modem IC. Different circuit board designs may have different analog IQ trace capacitances. Variations in analog IQ trace capacitances may cause variations in analog droop at band edges when cascaded with filters at the RF IC (e.g., baseband filters) and filters at the baseband modem IC (e.g., anti-aliasing filters).

The baseband modem IC may implement an undrooping functionality to fix and/or reduce the analog droop. The undrooping functionality may be based at least in part on undrooping filters. The undrooping filters may be designed to mitigate the analog droop based at least in part on a bench characterization of a frequency response. The bench characterization of the frequency response may need to be done for each circuit board design based on its unique routing, which may be a relatively expensive solution. Alternatively, the bench characterization of the frequency response may be done only once for a typical analog IQ trace capacitance, which may result in a tradeoff of routing flexibility to remain relatively close to the typical analog IQ trace capacitance, or which may result in a drop in undrooping performance. The usage of the typical analog IQ trace capacitance may limit flexibility in a circuit board design for each original equipment manufacturer (OEM), where the limited flexibility may be in terms of a mechanical packaging, form factor, size, and/or power optimization. The limited flexibility for the mechanical packaging, form factor, size, and/or power optimization may need to be aligned with the typical analog IQ trace capacitance.

Various aspects relate generally to droop compensation for analog interfaces between ICs of a UE. Some aspects more specifically relate to implementing droop compensation for high bandwidth analog IQ RF-to-modem (RF-modem) baseband interfaces of the UE. In some examples, a baseband modem IC of a UE may detect a signal. For example, the signal may be a transmit (Tx) signal. a receive (Rx) signal, or a looped back Tx signal that is received using a dedicated tracking receiver. The baseband modem IC may apply a droop compensation to reduce droop associated with the signal. The droop may be reduced based at least in part on an undroop filter configuration. The undroop filter configuration may be associated with a bin selected from a plurality of available bins. The bin may be selected based at least in part on a trace capacitance load (or an equivalent load circuit model), associated with an analog IQ interface between the baseband modem IC and an RF IC of the UE, being within a range of capacitance loads associated with the bin.

Particular aspects of the subject matter described in this disclosure can be implemented to realize one or more of the following potential advantages. In some examples, by implementing droop compensation for high bandwidth analog IQ RF-modem baseband interfaces, the described techniques can be used to allow a wide variety of circuit board designs. The circuit board designs may be on analog IQ interfaces for NR bandwidths that are greater than or equal to 20 MHz. Without such an approach, analog IQ interfaces for larger bandwidths (e.g., 100 MHz) may suffer from significant design limitations and require careful tradeoffs.

Droop compensation for high bandwidth analog IQ RF-modem baseband interfaces may require the use of different undroop coefficients for different trace lengths for the same IC pairing, in order to not compromise performance. A relatively expensive per-part compensation for droop may be avoided. Droop compensation for high bandwidth analog IQ RF-modem baseband interfaces may provide an ability to tradeoff memory (e.g., number of bins) with worst case undroop performance based at least in part on a tier (e.g., low, medium, or high) of a wireless device (e.g., a smart phone). Droop compensation for high bandwidth analog IQ RF-modem baseband interfaces may be useful for the use of analog IQ based radios with form factor flexibility, size, power, and/or cost as key parameters.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a global navigation satellite system (GNSS), a WLAN, a 3G RAT, a 4G RAT, and/or a RAT subsequent to 5G (e.g., 6G).

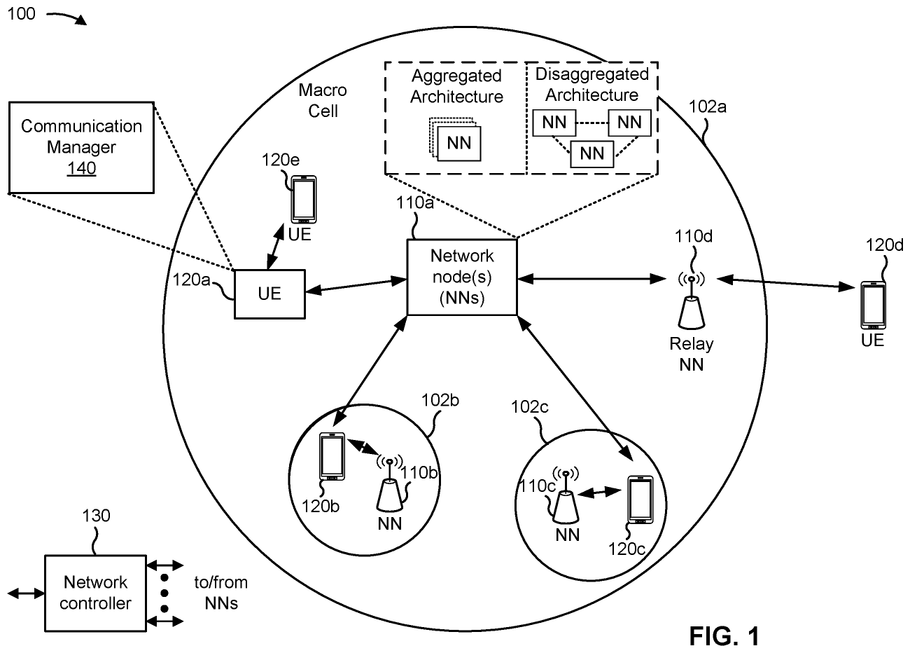

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may detect a signal, and apply a droop compensation to reduce droop associated with the signal, wherein the droop is reduced based at least in part on an undroop filter configuration, the undroop filter configuration is associated with a bin selected from a plurality of available bins, and the bin is selected based at least in part on a trace capacitance load, associated with an analog IQ interface between the baseband modem IC and an RF IC of the UE, being within a range of capacitance loads associated with the bin. Additionally, or alternatively, the communication manager 140 may perform one or more other operations described herein.

As indicated above, FIG. 1 is provided as an example. Other examples may differ from what is described with regard to FIG. 1.

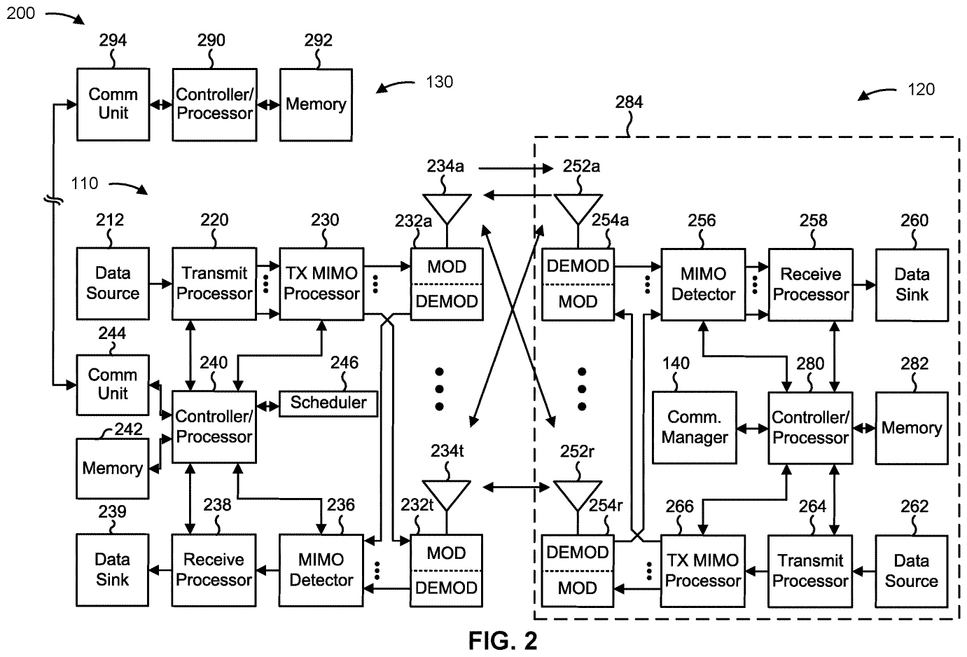

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more RF components, such as antennas 234 and a modem 232. In some examples, a network node 110 may include an interface, a communication component, or another component that facilitates communication with the UE 120 or another network node. Some network nodes 110 may not include RF components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (Tx) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

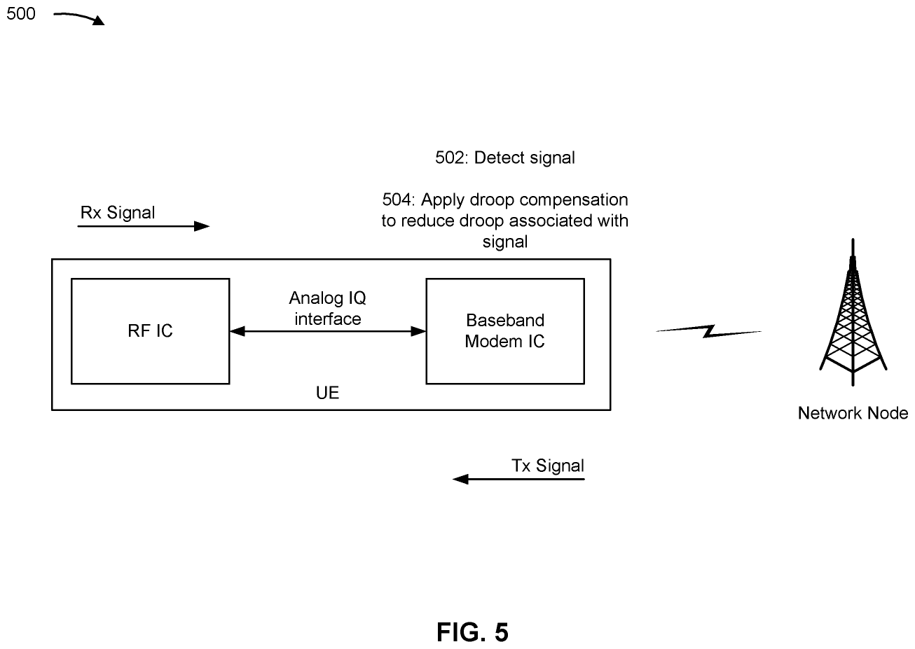

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a Tx MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the Tx MIMO processor 266. The transceiver may be used by a processor (e.g., the controller/processor 280) and the memory 282 to perform aspects of any of the methods described herein (e.g., with reference to FIGS. 5-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the Tx MIMO processor 230. The transceiver may be used by a processor (e.g., the controller/processor 240) and the memory 242 to perform aspects of any of the methods described herein (e.g., with reference to FIGS. 5-8).

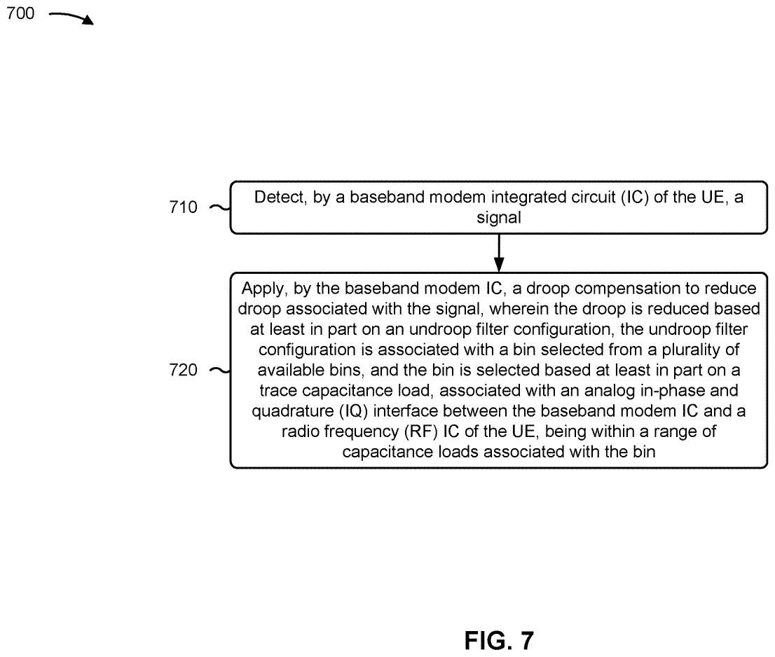

The controller/processor 240 of the network node 110, the controller/processor 280 of the UE 120, and/or any other component(s) of FIG. 2 may perform one or more techniques associated with droop compensation for analog interfaces between ICs of a UE, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for detecting, by a baseband modem IC of the UE, a signal; and/or means for applying, by the baseband modem IC, a droop compensation to reduce droop associated with the signal, wherein the droop is reduced based at least in part on an undroop filter configuration, the undroop filter configuration is associated with a bin selected from a plurality of available bins, and the bin is selected based at least in part on a trace capacitance load, associated with an analog IQ interface between the baseband modem IC and an RF IC of the UE, being within a range of capacitance loads associated with the bin. The means for the UE to perform operations described herein may include, for example, one or more of communication manager 140, antenna 252, modem 254, MIMO detector 256, receive processor 258, transmit processor 264, Tx MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the Tx MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

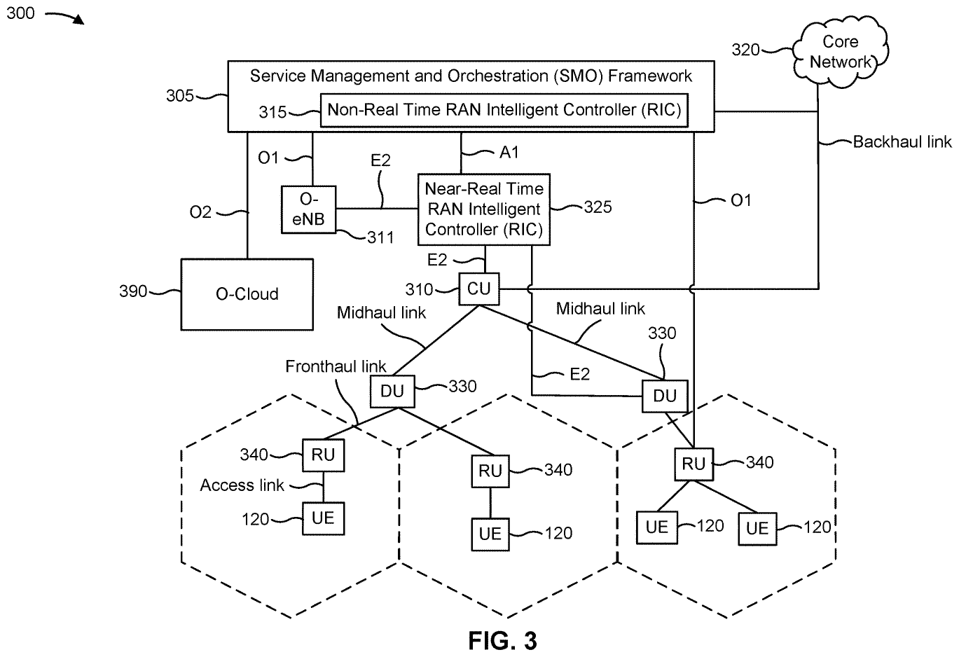

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

A modem architecture may have an RF front-end and a modem (e.g., a modem with data converters) on different IC packages, which may allow for separation and for independent selection of nodes, size, and/or power optimization for each IC package. In a circuit board, an analog IQ interface may be employed between an RF IC and a baseband modem IC. A circuit board routing and packaging solution may be designed for connecting an analog baseband signal from the RF IC to the baseband modem IC. Different circuit board designs may have different analog IQ trace capacitances. Variations in analog IQ trace capacitances may cause variations in analog droop at band edges when cascaded with filters at the RF IC (e.g., baseband filters) and filters at the baseband modem IC (e.g., anti-aliasing filters).

The baseband modem IC may implement an undrooping functionality to fix and/or reduce the analog droop. The undrooping functionality may be based at least in part on undrooping filters. The undrooping filters may be designed to mitigate the analog droop based at least in part on a bench characterization of a frequency response. The bench characterization of the frequency response may need to be done for each circuit board design based on its unique routing, which may be a relatively expensive solution. Alternatively, the bench characterization of the frequency response may be done only once for a typical analog IQ trace capacitance, which may result in a tradeoff of routing flexibility to remain relatively close to the typical analog IQ trace capacitance, or which may result in a drop in undrooping performance. The usage of the typical analog IQ trace capacitance may limit flexibility in a circuit board design for each OEM, where the limited flexibility may be in terms of a mechanical packaging, form factor, size, and/or power optimization. The limited flexibility for the mechanical packaging, form factor, size, and/or power optimization may need to be aligned with the typical analog IQ trace capacitance.

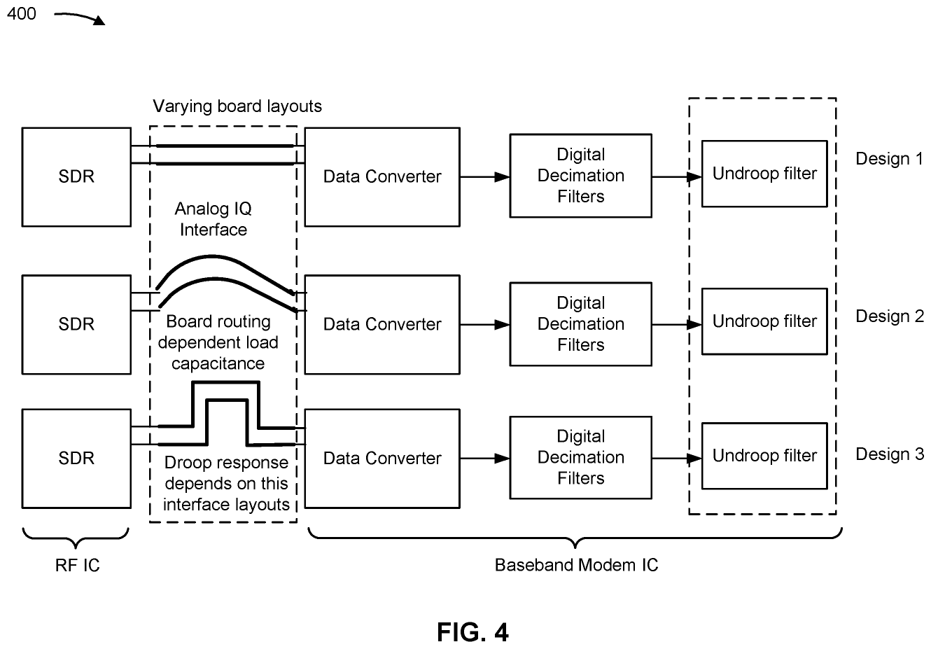

FIG. 4 is a diagram illustrating an example 400 of circuit board layout variations, in accordance with the present disclosure.

As shown in FIG. 4, a software-defined radio (SDR) of an RF IC may be coupled to a baseband modem IC using varying circuit board layouts. Different circuit board layouts may utilize different routings (e.g., routings with different routing curvatures) between the RF IC and the baseband modem IC. The RF IC may be coupled to the baseband modem IC via an analog IQ interface. The analog IQ interface may be associated with a circuit board routing dependent capacitance load. A droop response may depend on a layout of the analog IQ interface. Each baseband modem IC, or modem package, may include a data converter, digital decimation filters, and an undroop filter. Other examples may include routing on different board layers, and/or a use of a connector or passthrough boards.

A single undroop filter may need to handle circuit board dependent layout variations, and using the single undroop filter for the varying circuit board layouts may limit flexibility in circuit board design in terms of mechanical packaging, form factor, size, and/or power optimization. Certain design guidelines may be provided based at least in part on the single undroop filter that is available. The design guidelines may provide certain design constraints in terms of a maximum loading, a maximum tolerable capacitance, and/or a maximum trace length. However, such design constraints may be more cumbersome with larger bandwidths. For example, such design constraints may be suitable for analog IQ interfaces associated with receiver bandwidths of 20 MHz, but may be problematic for analog IQ interfaces associated with receiver bandwidths of 200 MHz. As a result, a restriction to the single undroop filter may degrade an overall performance of a transmitter/receiver.

As indicated above, FIG. 4 is provided as an example. Other examples may differ from what is described with regard to FIG. 4.

In various aspects of techniques and apparatuses described herein, a baseband modem IC of a UE may detect a signal. For example, the signal may be a Tx signal, an Rx signal, or a looped back Tx signal that is received using a dedicated tracking receiver. The baseband modem IC may apply a droop compensation to reduce droop associated with the signal. The droop reduced may be based at least in part on an undroop filter configuration. The undroop filter configuration may be associated with a bin selected from a plurality of available bins. The bin may be selected based at least in part on a trace capacitance load (or an equivalent load circuit model), associated with an analog IQ interface between the baseband modem IC and an RF IC of the UE, being within a range of capacitance loads associated with the bin.

In some aspects, the trace capacitance load (or the equivalent load circuit model) may be based at least in part on a specific UE design. The bin, of the plurality of available bins, may be associated with the range of capacitance loads, a circuit model for a median loading (e.g., a median capacitance load), and undroop filter coefficients. The undroop filter coefficients may be associated with the undroop filter configuration. The plurality of available bins may be defined based at least in part on validated models for values of trace capacitive loads. Further, a plurality of undroop filter configurations, corresponding to the plurality of available bins, may be available for varying printed circuit board (PCB) layouts, and the varying PCB layouts may be based at least in part on routing variations associated with analog IQ interfaces between RF ICs and baseband modem ICs.

In some aspects, different bins may be used to characterize the analog IQ interface. Bins may be used for developing multiple models for the range of capacitance loads, where each model may use a circuit model for a median loading (e.g., a median capacitance load) across that bin range. A response of a baseband filter, a capacitance load, an anti-aliasing filter, and the trace capacitance load may be simulated, with a median capacitance load of each bin, and multiple undrooping filter models may be generated based at least in part on the simulated response. The multiple undrooping filter models may be based at least in part on multiple capacitance loads. A PCB capacitance load may be simulated and/or measured using standard S-parameter de-embedding techniques, and then an appropriate bin (e.g., low bin, medium bin, or high bin) may be determined, depending on the capacitance load. A circuit board trace capacitance may be determined in order to select the correct bin. An undroop filter model, of the multiple undrooping filter models, may be selected, corresponding to the bin, without any bench characterization for droop. In other words, a plurality of available undroop filters may be selected based on an individual circuit board design. As a result, increased flexibility may be provided in circuit board design without requiring bench characterization for each circuit board design. The circuit board design may be applicable to Tx modules, Rx modules, and/or feedback receiver (FBRx) modules.

As an example, when a range of capacitance load is 0.7 picofarads (pF) to 10 pF, a low bin may range from 0.7 pF to 3 pF with a median capacitance load of 1.8 pF, a medium bin may range from 3 pF to 6.5 pF with a median capacitance load of 4.7 pF, and a high bin may range from 6.5 pF to 10 pF with a median capacitance load of 8.2 pF. In this example, a median capacitance load of the bins may be 1.8 pF, 4.7 pF, and 8.2 pF, respectively.

In some aspects, by implementing droop compensation for high bandwidth analog IQ RF-modem baseband interfaces, as described herein, a wide variety of circuit board designs may be allowed. The circuit board designs may be on analog IQ interfaces for NR bandwidths that are greater than or equal to 20 MHz. Without such an approach, analog IQ interfaces for larger bandwidths (e.g., 100 MHz) may suffer from significant design limitations and require careful tradeoffs. Droop compensation for high bandwidth analog IQ RF-modem baseband interfaces may enable the use of different undroop coefficients for different trace lengths for the same IC pairing, but without compromising performance. A relatively expensive per-part droop compensation may be avoided. A device droop characterization time may be limited to model validation. A customization for circuit board designs may be provided through a binning framework. Droop compensation for high bandwidth analog IQ RF-modem baseband interfaces may provide an ability to trade off memory (e.g., number of bins) with worst case undroop performance based at least in part on a tier (e.g., low, medium, or high) of a wireless device (e.g., a smart phone). Droop compensation for high bandwidth analog IQ RF-modem baseband interfaces may be useful for the use of analog IQ based radios with form factor flexibility, size, power, and/or cost as key parameters. A circuit board stackup, form factor, and/or trace routing between an SDR and a modem may be customized, where the SDR and the modem may be physically separated and connected through off-board connectors with a relatively large capacitive load.

FIG. 5 is a diagram illustrating an example 500 associated with droop compensation for analog interfaces between integrated circuits of a UE, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

In some aspects, the UE may include an RF IC and a baseband modem IC. The RF IC may include an SDR. The modem may include data converters, digital decimation filters, and/or an undroop filter. The RF IC and the baseband modem IC may be connected via an analog IQ interface.

As shown by reference number 502, the baseband modem IC of the UE may detect a signal. The signal may be an Rx signal received from the network node. The signal may be a Tx signal to be transmitted to the network node. The signal may be a looped back Tx signal that is received using a dedicated tracking receiver.

As shown by reference number 504, the baseband modem IC may apply a droop compensation to reduce droop associated with the signal. The baseband modem IC may apply the droop compensation to reduce an analog droop associated with the signal, where the analog droop may be based at least in part on variations in analog IQ trace capacitances. The variations in analog IQ trace capacitances may be based at least in part on variations in routing associated with the analog IQ interface. The baseband modem IC may apply the droop compensation using the undroop filter. The undroop filter may be associated with undroop filter coefficients, which may allow for a reduction of the analog droop in the signal.

In some aspects, the droop compensation may support different undroop filter coefficients for different trace lengths, different PCB stackups, and/or different form factors, depending on the specific UE design. A plurality of undroop filter configurations, corresponding to the plurality of available bins, may be available for varying PCB layouts, and the varying PCB layouts may be based at least in part on routing variations associated with analog IQ interfaces between RF ICs and baseband modem ICs.

In some aspects, when the signal is the Rx signal, the RF IC may receive the Rx signal at an antenna input. The baseband modem IC may apply the droop compensation to a down-converted Rx signal to obtain an undrooped Rx waveform. In some aspects, when the signal is the Tx signal, the baseband modem IC may generate a baseband Tx waveform. The baseband modem IC may apply the droop compensation to the baseband Tx waveform to obtain an undrooped Tx signal, after an up-conversion, at an antenna output. In some aspects, the baseband modem IC may apply the droop compensation to a looped back down-converted Tx signal used to track a Tx power to obtain an estimate of the Tx power, calculate a feedback correction factor, and apply a correction to: obtain high resolution power tracking accuracy, obtain group delay synchronization, or linearize a nonlinear input-output relationship in a transmitter.

In some aspects, the undrooping may be based at least in part on an undroop filter configuration. The undroop filter configuration may be associated with a bin selected from a plurality of available bins. The bin may be selected based at least in part on a trace capacitance load (or an equivalent load circuit model), associated with an analog IQ interface between the baseband modem IC and the RF IC, being within a range of capacitance loads associated with the bin. A load circuit model may be a capacitance load, or the load circuit model may be a combination of resistance, capacitance, and/or inductance. In some aspects, the bin may be selected based at least in part on a sweep of each of the plurality of available bins, and the sweep may include measuring a residual droop associated with each of the plurality of available bins. Alternatively, the bin may be selected based at least in part on a sweep of each of the plurality of available bins during an operation of the UE, and the sweep may include measuring UE data throughput performance metrics associated with each of the plurality of available bins.

In some aspects, the bin, of the plurality of available bins, may be associated with a range of capacitance loads, a median capacitance load, and the undroop filter coefficients. The undroop filter coefficients may be associated with the undroop filter configuration. The plurality of available bins may be defined based at least in part on validated models for values of trace capacitive loads. The plurality of available bins may be based at least in part on a uniform capacitance size. The plurality of available bins may be based at least in part on a maximum droop error. The plurality of available bins may be based at least in part on a target market. In some aspects, the undroop filter coefficients associated with the undroop filter configuration may be dynamically tuned based at least in part on a past UE usage history. In some aspects, the undroop filter coefficients associated with the undroop filter configuration may be predictively tuned using an AI/ML model. The undroop filter coefficients may be predictively tuned based at least in part on expected environmental conditions. The undroop filter coefficients may be predictively tuned based at least in part on internal device parameters (e.g., chip temperature).

In some aspects, the trace capacitance load (or the equivalent load circuit model) may be based at least in part on a specific UE design. The trace capacitance load may be based at least in part on a capacitance load characterization. The capacitance load characterization may be based at least in part on a PCB signal integrity (SI) simulation or measurement.

Alternatively, the capacitance load characterization may be based at least in part on a measurement of de-embedded parameters of a PCB trace and a fit to a discrete component model.

In some aspects, droop compensation for high bandwidth analog IQ RF-modem baseband interfaces may be defined. Multiple bins of trace capacitance and associated undroop coefficients may be defined, and a capacitance load may be characterized for a given circuit board design. Undroop coefficients corresponding to a particular bin may be selected for optimal droop performance for the UE (e.g., for a specific UE). In some aspects, the bins of trace capacitance may be determined using various approaches. Bins of uniform capacitance size may be selected (e.g., one bin for a 1 pF range of capacitance load). Bins corresponding to maximum droop error may be selected (e.g., one bin for a maximum droop error of 1 dB post correction). Bins corresponding to target markets may be selected. For example, one bin may be defined for each of a premium tier (e.g., multi-layer stackup and routing, and/or small trace length), a mid-tier (e.g., multi-layer stackup, single layer routing, and/or moderate trace length), and a low-tier (e.g., reduced number of layers, single layer routing, and/or large trace length).

In some aspects, the capacitance load characterization and/or the bin selection may be based at least in part on performing a PCB simulation and extracting a circuit model for capacitance load. The capacitance load characterization and/or the bin selection may be based at least in part on measuring de-embedded S-parameters of a PCB trace and fitting the discrete component model. The capacitance load characterization and/or the bin selection may be based at least in part on dynamically determining the bin by sweeping through different available bins and measuring the residual droop. The sweeping through the different available bins may be in an online mode or in an offline mode, and may involve no prior capacitance load characterization. In some aspects, specific UE design history and field testing may be used to optimally segregate the bins and define specific performance metrics for bin and/or undroop filter selection, which may be based at least in part on specific use scenarios.

In a past approach, which was limited to a 20 MHz analog IQ bandwidth, a circuit board was carefully designed to limit a capacitive load to be within a range of a typical design. A single bench characterization was performed on the circuit board. Undroop filter coefficients were generated for testing of the circuit board. A range of capacitance load was limited based at least in part on a tolerable droop error. In the past approach, a single undroop filter configuration was defined for each band. However, the past approach limited the range of supported capacitance loads in analog IQ paths, and was only suitable for smaller bandwidths without performance tradeoffs.

In some aspects, a flexible choice of circuit boards may be available because a bench characterization is only relied on for model validation. A model may be validated for a single value of trace capacitive loading on the circuit board. Droop bins may be defined and median capacitances for each bin may be selected. Undroop filter coefficients may be generated for each bin, either in an online mode or in an offline mode.

In some aspects, in a first approach, an appropriate bin may be selected based at least in part on a specific circuit board design. No artificial limits on trace capacitance may be imposed for droop. The trace capacitance may only be constrained by other RF IC design metrics for maximum tolerable capacitance load. In some implementations, multiple options of undroop filter coefficients may be available for selection, which may be based at least in part on a specific circuit board design and a design specification to support a relatively large bandwidth (e.g., analog IQ bandwidths of 100 MHz or more). Superior flexibility without expensive per-part calibration may be achieved.

In some aspects, in a second approach, an online algorithm may be used to measure an online droop with each bin, and an optimal bin may be selected under a test scenario. A UE may leverage Tx-Rx or Tx-FBRx loopback paths for this approach. In a third approach, an online learning algorithm may be designed that measures an online droop with each bin, an optimal bin may be selected under a test scenario, and undroop filter coefficients may be dynamically tuned using a previous UE usage history. The undroop filter coefficients may be dynamically tuned using AI/ML techniques, which may result in a superior droop performance.

In the past approach, a capacitance load may be selected to be characterized, undroop filter coefficients may be generated, and a circuit board may be validated. Design guidance for circuit boards may be published, which may include a maximum allowed capacitive load. A circuit board design may be generated to conform to the design guidelines, and the circuit board design may use the provided undroop filter coefficients. When the circuit board design violates the design guidance, an unbounded performance tradeoff may need to be accepted.

In some aspects, a range of capacitance load for each bin may be provided. For example, a first bin may be associated with a range of (C1−C2), a second bin may be associated with a range of (C2−C3), and an Nth bin may be associated with a range of (Cn−(Cn+1)). A circuit board may be designed, and an expected circuit board trace capacitance load may be estimated, based at least in part on a simulation or a previous design history. A bin from a plurality of bins may be selected based at least in part on the expected circuit board trace capacitance load. When the selected bin does not satisfy a droop requirement, an iteration of a bin selection may be performed. When the selected bin satisfies the droop requirement, an undrooping filter configuration may be finalized, where a performance tradeoff may be bounded by a bin size.

In some aspects, droop compensation for high bandwidth analog IQ RF-modem baseband interfaces may be used for analog IQ modem-SDR interfaces for UEs required to support 5G NR uplink bandwidths of 20 MHz and beyond, and which may include the use of power optimization features such as digital pre-distortion (DPD) and average-power tracking (APT), and additional features such as self-test adjacent channel leakage ratio (ACLR) measurements. Droop compensation for high bandwidth analog IQ RF-modem baseband interfaces may be used for analog IQ modem-SDR interfaces for UEs required to support 5G NR downlink bandwidths of up to 20 MHz. Droop compensation for high bandwidth analog IQ RF-modem baseband interfaces may be used for analog IQ modem-SDR interfaces for wearable UEs, which may be associated with relatively large variation in analog IQ trace loading between a modem and an SDR. Droop compensation for high bandwidth analog IQ RF-modem baseband interfaces may be used for analog IQ modem-SDR interfaces for extended reality (XR) for XR glasses, where a modem and an SDR may be forced to be separated by relatively large analog IQ traces due to physical form factor limitations.

In some aspects, droop compensation for high bandwidth analog IQ RF-modem baseband interfaces, as described herein, may be associated with various undroop applications. For a Tx signal, an expected analog droop may be corrected before the Tx signal is transmitted. Undrooping may be applied at a modem before the Tx signal is transmitted over an analog IQ interface and RF IC. For an Rx signal, droop in a received Rx signal may be corrected. The modem may receive the Rx signal, which may be received at RF and analog portions of the modem, and undrooping may be applied at the modem to correct for this droop. For an FBRx signal, droop may be corrected like an Rx signal. A Tx signal transmitted by a transmitter may be fed back as the Rx signal to an Rx chain for analysis on the modem, and the undrooping may be applied to the Rx signal that is fed back to the Rx chain.

As indicated above, FIG. 5 is provided as an example. Other examples may differ from what is described with regard to FIG. 5.

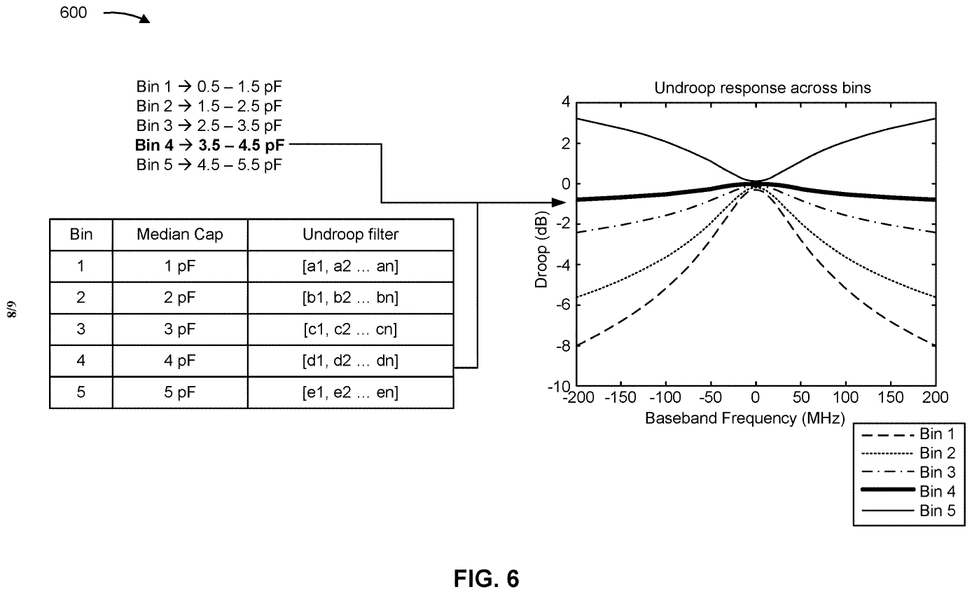

FIG. 6 is a diagram illustrating an example 600 of undroop responses across bins, in accordance with the present disclosure.

As shown in FIG. 6, a plurality of bins may be defined for different ranges of capacitances for analog IQ traces. For example, a first bin may be associated with a range of 0.5 pF to 1.5 pF, a median capacitance load of 1 pF, and an undroop filter denoted by [a1, a2 . . . an]. A second bin may be associated with a range of 1.5 pF to 2.5 pF, a median capacitance load of 2 pF, and an undroop filter denoted by [b1, b2. . . bn]. A third bin may be associated with a range of 2.5 pF to 3.5 pF, a median capacitance load of 3 pF, and an undroop filter denoted by [c1, c2 . . . cn]. A fourth bin may be associated with a range of 3.5 pF to 4.5 pF, a median capacitance load of 4 pF, and an undroop filter denoted by [d1, d2 . . . dn]. A fifth bin may be associated with a range of 4.5 pF to 5.5 pF, a median capacitance load of 5 pF, and an undroop filter denoted by [e1, e2 . . . en]. An undroop response may be calculated across bins.

For each bin, a droop (in dB) may be calculated in terms of a baseband frequency (in megahertz (MHz)). In this example, the fourth bin may be associated with a relatively flat undroop response, as compared to the other bins, so the fourth bin and corresponding undroop filter may be selected for a design.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with droop compensation for analog interfaces between integrated circuits of a UE.

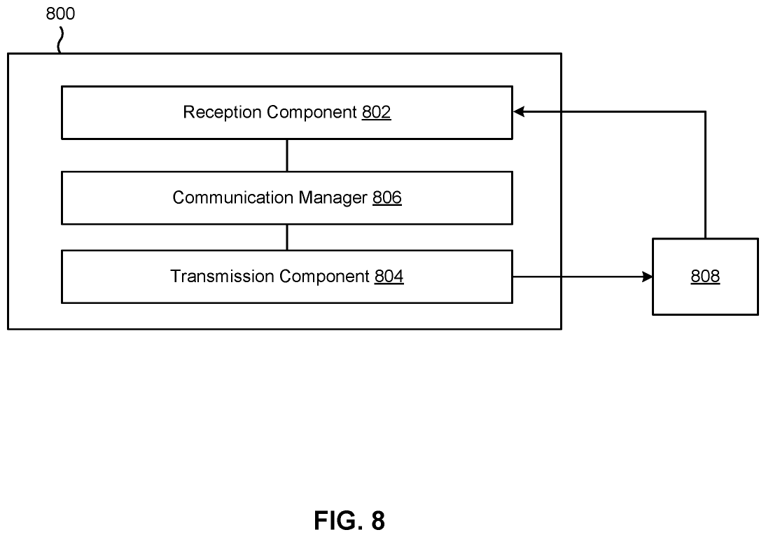

As shown in FIG. 7, in some aspects, process 700 may include detecting a signal (block 710). For example, the UE (e.g., using reception component 802 and/or communication manager 806, depicted in FIG. 8) may detect a signal, as described above.

As further shown in FIG. 7, in some aspects, process 700 may include applying a droop compensation to reduce droop associated with the signal, wherein: the droop is reduced based at least in part on an undroop filter configuration, the undroop filter configuration is associated with a bin selected from a plurality of available bins, and the bin is selected based at least in part on a trace capacitance load, associated with an analog IQ interface between the baseband modem IC and an RF IC of the UE, being within a range of capacitance loads associated with the bin (block 720). For example, the UE (e.g., using communication manager 806, depicted in FIG. 8) may apply a droop compensation to reduce droop associated with the signal, wherein: the droop is reduced based at least in part on an undroop filter configuration, the undroop filter configuration is associated with a bin selected from a plurality of available bins, and the bin is selected based at least in part on a trace capacitance load, associated with an analog IQ interface between the baseband modem IC and an RF IC of the UE, being within a range of capacitance loads associated with the bin, as described above.

Process 700 may include additional aspects, such as any single aspect or any combination of aspects described below and/or in connection with one or more other processes described elsewhere herein.

In a first aspect, the bin, of the plurality of available bins, is associated with the range of capacitance loads, a circuit model for a median loading, and undroop filter coefficients, the undroop filter coefficients are associated with the undroop filter configuration, and the plurality of available bins are defined based at least in part on validated models for values of trace capacitive loads.

In a second aspect, alone or in combination with the first aspect, the trace capacitance load is based at least in part on a specific UE design.

In a third aspect, alone or in combination with one or more of the first and second aspects, the plurality of available bins are based at least in part on a uniform capacitance size.

In a fourth aspect, alone or in combination with one or more of the first through third aspects, the plurality of available bins are based at least in part on a maximum droop error.

In a fifth aspect, alone or in combination with one or more of the first through fourth aspects, the plurality of available bins are based at least in part on a target market.

In a sixth aspect, alone or in combination with one or more of the first through fifth aspects, the trace capacitance load is based at least in part on a capacitance load characterization, and the capacitance load characterization is based at least in part on a PCB SI simulation or measurement, or the capacitance load characterization is based at least in part on a measurement of de-embedded parameters of a PCB trace and a fit to a discrete component model.

In a seventh aspect, alone or in combination with one or more of the first through sixth aspects, the bin is selected based at least in part on a sweep of each of the plurality of available bins, and the sweep includes measuring a residual droop associated with each of the plurality of available bins, or the bin is selected based at least in part on a sweep of each of the plurality of available bins during an operation of the UE, and the sweep includes measuring UE data throughput performance metrics associated with each of the plurality of available bins.

In an eighth aspect, alone or in combination with one or more of the first through seventh aspects, undrooping filter coefficients associated with the undroop filter configuration are tuned based at least in part on a past UE usage history; or undroop filter coefficients associated with the undroop filter configuration are predictively tuned using a machine learning model, and the undroop filter coefficients are predictively tuned based at least in part on expected environmental conditions at a location within a network or internal device parameters.

In a ninth aspect, alone or in combination with one or more of the first through eighth aspects, the droop compensation supports different undroop filter coefficients for one or more of: different trace lengths, different PCB stackups, or different form factors, depending on a specific UE design.

In a tenth aspect, alone or in combination with one or more of the first through ninth aspects, a plurality of undroop filter configurations, corresponding to the plurality of available bins, are available for varying PCB layouts, and the varying PCB layouts are based at least in part on routing variations associated with analog IQ interfaces between RF ICs and baseband modem ICs.

In an eleventh aspect, alone or in combination with one or more of the first through tenth aspects, the signal is an Rx signal, a Tx signal, or a looped back Tx signal that is received using a dedicated tracking receiver.

In a twelfth aspect, alone or in combination with one or more of the first through eleventh aspects, process 700 includes receiving, by the RF IC, the Rx signal at an antenna input, and applying, by the baseband modem IC, the droop compensation to a down-converted Rx signal to obtain an undrooped Rx waveform.

In a thirteenth aspect, alone or in combination with one or more of the first through twelfth aspects, process 700 includes generating, by the baseband modem IC, a baseband Tx waveform, and applying, by the baseband modem IC, the droop compensation to the baseband Tx waveform to obtain an undrooped Tx signal, after an up-conversion, at an antenna output.

In a fourteenth aspect, alone or in combination with one or more of the first through thirteenth aspects, process 700 includes applying, by the baseband modem IC, the droop compensation to a looped back down-converted Tx signal used to track a Tx power to obtain an estimate of the Tx power, calculate a feedback correction factor, and apply a correction to: obtain high resolution power tracking accuracy, obtain group delay synchronization, or linearize a nonlinear input-output relationship in a transmitter.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may detect a signal. The communication manager 806 may apply a droop compensation to reduce droop associated with the signal, wherein the droop is reduced based at least in part on an undroop filter configuration, the undroop filter configuration is associated with a bin selected from a plurality of available bins, and the bin is selected based at least in part on a trace capacitance load, associated with an analog IQ interface between the baseband modem IC and an RF IC of the UE, being within a range of capacitance loads associated with the bin.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components.

Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: detecting, by a baseband modem integrated circuit (IC) of the UE, a signal; and
applying, by the baseband modem IC, a droop compensation to reduce droop associated with the signal, wherein: the droop is reduced based at least in part on an undroop filter configuration, the undroop filter configuration is associated with a bin selected from a plurality of available bins, and the bin is selected based at least in part on a trace capacitance load, associated with an analog in-phase and quadrature (IQ) interface between the baseband modem IC and a radio frequency (RF) IC of the UE, being within a range of capacitance loads associated with the bin.

Aspect 2: The method of Aspect 1, wherein: the bin, of the plurality of available bins, is associated with the range of capacitance loads, a circuit model for a median loading, and undroop filter coefficients; the undroop filter coefficients are associated with the undroop filter configuration; and the plurality of available bins are defined based at least in part on validated models for values of trace capacitive loads.

Aspect 3: The method of any of Aspects 1-2, wherein the trace capacitance load is based at least in part on a specific UE design.

Aspect 4: The method of any of Aspects 1-3, wherein the plurality of available bins are based at least in part on a uniform capacitance size.

Aspect 5: The method of any of Aspects 1-4, wherein the plurality of available bins are based at least in part on a maximum droop error.

Aspect 6: The method of any of Aspects 1-5, wherein the plurality of available bins are based at least in part on a target market.

Aspect 7: The method of any of Aspects 1-6, wherein the trace capacitance load is based at least in part on a capacitance load characterization, and wherein: the capacitance load characterization is based at least in part on a printed circuit board (PCB) signal integrity (SI) simulation or measurement; or the capacitance load characterization is based at least in part on a measurement of de-embedded parameters of a PCB trace and a fit to a discrete component model.

Aspect 8: The method of any of Aspects 1-7, wherein: the bin is selected based at least in part on a sweep of each of the plurality of available bins, and the sweep includes measuring a residual droop associated with each of the plurality of available bins, or the bin is selected based at least in part on a sweep of each of the plurality of available bins during an operation of the UE, and the sweep includes measuring UE data throughput performance metrics associated with each of the plurality of available bins.

Aspect 9: The method of any of Aspects 1-8, wherein: undroop filter coefficients associated with the undroop filter configuration are tuned based at least in part on a past UE usage history; or undroop filter coefficients associated with the undroop filter configuration are predictively tuned using a machine learning model, and the undroop filter coefficients are predictively tuned based at least in part on expected environmental conditions at a location within a network or internal device parameters.

Aspect 10: The method of any of Aspects 1-9, wherein the droop compensation supports different undroop filter coefficients for one or more of: different trace lengths, different printed circuit board (PCB) stackups, or different form factors, depending on a specific UE design.

Aspect 11: The method of any of Aspects 1-10, wherein a plurality of undroop filter configurations, corresponding to the plurality of available bins, are available for varying printed circuit board (PCB) layouts, and the varying PCB layouts are based at least in part on routing variations associated with analog IQ interfaces between RF ICs and baseband modem ICs.

Aspect 12: The method of any of Aspects 1-11, wherein the signal is a receive (Rx) signal, a transmit (Tx) signal, or a looped back Tx signal that is received using a dedicated tracking receiver.

Aspect 13: The method of Aspect 12, further comprising: receiving, by the RF IC, the Rx signal at an antenna input; and applying, by the baseband modem IC, the droop compensation to a down-converted Rx signal to obtain an undrooped Rx waveform.

Aspect 14: The method of Aspect 12, further comprising: generating, by the baseband modem IC, a baseband Tx waveform; and applying, by the baseband modem IC, the droop compensation to the baseband Tx waveform to obtain an undrooped Tx signal, after an up-conversion, at an antenna output.

Aspect 15: The method of Aspect 12, further comprising: applying, by the baseband modem IC, the droop compensation to a looped back down-converted Tx signal used to track a Tx power to obtain an estimate of the Tx power, calculate a feedback correction factor, and apply a correction to: obtain high resolution power tracking accuracy, obtain group delay synchronization, or linearize a nonlinear input-output relationship in a transmitter.

Aspect 16: An apparatus for wireless communication at a device, comprising a processor; memory coupled with the processor; and instructions stored in the memory and executable by the processor to cause the apparatus to perform the method of one or more of Aspects 1-15.

Aspect 17: A device for wireless communication, comprising a memory and one or more processors coupled to the memory, the one or more processors configured to perform the method of one or more of Aspects 1-15.

Aspect 18: An apparatus for wireless communication, comprising at least one means for performing the method of one or more of Aspects 1-15.

Aspect 19: A non-transitory computer-readable medium storing code for wireless communication, the code comprising instructions executable by a processor to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors coupled to the one or more memories, the one or more memories including instructions executable by the one or more processors to cause the UE to:
detect, by a baseband modem integrated circuit (IC) of the UE, a signal; and
apply, by the baseband modem IC, a droop compensation to reduce droop associated with the signal, wherein:
the droop is reduced based at least in part on an undroop filter configuration,
the undroop filter configuration is associated with a bin selected from a plurality of available bins, and
the bin is selected based at least in part on a trace capacitance load, associated with an analog in-phase and quadrature (IQ) interface between the baseband modem IC and a radio frequency (RF) IC of the UE, being within a range of capacitance loads associated with the bin.

2. The UE of claim 1, wherein:
the bin, of the plurality of available bins, is associated with the range of capacitance loads, a circuit model for a median loading, and undroop filter coefficients;
the undroop filter coefficients are associated with the undroop filter configuration; and
the plurality of available bins are defined based at least in part on validated models for values of trace capacitive loads.

3. The UE of claim 1, wherein the trace capacitance load is based at least in part on a specific UE design.

4. The UE of claim 1, wherein the plurality of available bins are based at least in part on a uniform capacitance size.

5. The UE of claim 1, wherein the plurality of available bins are based at least in part on a maximum droop error.

6. The UE of claim 1, wherein the plurality of available bins are based at least in part on a target market.

7. The UE of claim 1, wherein the trace capacitance load is based at least in part on a capacitance load characterization, and wherein:
the capacitance load characterization is based at least in part on a printed circuit board (PCB) signal integrity (SI) simulation or measurement; or
the capacitance load characterization is based at least in part on a measurement of de-embedded parameters of a PCB trace and a fit to a discrete component model.

8. The UE of claim 1, wherein:
the bin is selected based at least in part on a sweep of each of the plurality of available bins, and the sweep includes measuring a residual droop associated with each of the plurality of available bins; or
the bin is selected based at least in part on a sweep of each of the plurality of available bins during an operation of the UE, and the sweep includes measuring UE data throughput performance metrics associated with each of the plurality of available bins.

9. The UE of claim 1, wherein:
undroop filter coefficients associated with the undroop filter configuration are tuned based at least in part on a past UE usage history; or
undroop filter coefficients associated with the undroop filter configuration are predictively tuned using a machine learning model, and the undroop filter coefficients are predictively tuned based at least in part on expected environmental conditions at a location within a network or internal device parameters.

10. The UE of claim 1, wherein the droop compensation supports different undroop filter coefficients for one or more of: different trace lengths, different printed circuit board (PCB) stackups, or different form factors, depending on a specific UE design.

11. The UE of claim 1, wherein a plurality of undroop filter configurations, corresponding to the plurality of available bins, are available for varying printed circuit board (PCB) layouts, and the varying PCB layouts are based at least in part on routing variations associated with analog IQ interfaces between RF ICs and baseband modem ICs.

12. The UE of claim 1, wherein the signal is a receive (Rx) signal, a transmit (Tx) signal, or a looped back Tx signal that is received using a dedicated tracking receiver.

13. The UE of claim 12, wherein the one or more memories further include instructions executable by the one or more processors to cause the UE to:
receive, by the RF IC, the Rx signal at an antenna input; and
apply, by the baseband modem IC, the droop compensation to a down-converted Rx signal to obtain an undrooped Rx waveform.

14. The UE of claim 12, wherein the one or more memories further include instructions executable by the one or more processors to cause the UE to:
generate, by the baseband modem IC, a baseband Tx waveform; and
apply, by the baseband modem IC, the droop compensation to the baseband Tx waveform to obtain an undrooped Tx signal, after an up-conversion, at an antenna output.

15. The UE of claim 12, wherein the one or more memories further include instructions executable by the one or more processors to cause the UE to:
apply, by the baseband modem IC, the droop compensation to a looped back down-converted Tx signal used to track a Tx power to obtain an estimate of the Tx power, calculate a feedback correction factor, and apply a correction to: obtain high resolution power tracking accuracy, obtain group delay synchronization, or linearize a nonlinear input-output relationship in a transmitter.

16. A method of wireless communication performed by a user equipment (UE), comprising:
detecting, by a baseband modem integrated circuit (IC) of the UE, a signal; and
applying, by the baseband modem IC, a droop compensation to reduce droop associated with the signal, wherein:
the droop is reduced based at least in part on an undroop filter configuration,
the undroop filter configuration is associated with a bin selected from a plurality of available bins, and
the bin is selected based at least in part on a trace capacitance load, associated with an analog in-phase and quadrature (IQ) interface between the baseband modem IC and a radio frequency (RF) IC of the UE, being within a range of capacitance loads associated with the bin.

17. The method of claim 16, wherein:
the bin, of the plurality of available bins, is associated with the range of capacitance loads, a circuit model for a median loading, and undroop filter coefficients;
the undroop filter coefficients are associated with the undroop filter configuration; and
the plurality of available bins are defined based at least in part on validated models for values of trace capacitive loads.

18. The method of claim 16, wherein the trace capacitance load is based at least in part on a specific UE design.

19. The method of claim 16, wherein:
the plurality of available bins are based at least in part on a uniform capacitance size;
the plurality of available bins are based at least in part on a maximum droop error; or
the plurality of available bins are based at least in part on a target market.

20-29. (canceled)

30. An apparatus for wireless communication, comprising:
means for detecting, by a baseband modem integrated circuit (IC) of the apparatus, a signal; and
means for applying a droop compensation to reduce droop associated with the signal, wherein:
the droop is reduced based at least in part on an undroop filter configuration,
the undroop filter configuration is associated with a bin selected from a plurality of available bins, and
the bin is selected based at least in part on a trace capacitance load, associated with an analog in-phase and quadrature (IQ) interface between the baseband modem IC and a radio frequency (RF) IC of the apparatus, being within a range of capacitance loads associated with the bin.
